(19) United States
(12) Patent Application Publication
(10) Pub. No.: US 2004/0111466 A1
(43) Pub. Date: Jun. 10, 2004

(54) System and method for defining process information for web-services

(76) Inventors: Dorothea I. Beringer, Sergy (FR); Guillaume N. Vambenepe, Mountain View, CA (US)

Correspondence Address: HEWLETT-PACKARD COMPANY, Intellectual Property Administration, P. O. Box 272400, Fort Collins, CO, 80527-2400, US

(21) Appl. No.: 10/315,961

(22) Filed: Dec. 9, 2002

(51) Int. Cl. G06F 15/16

(52) U.S. Cl. 709/203

(57) ABSTRACT

In accordance with an embodiment of the present invention, an electronic message comprising a port name element operable to specify at least one port of a server for providing a web-service, an operation name element operable to specify at least one operation for the at least one port and an operation message name element operable to specify at least one operation message for the at least one operation is disclosed.

© Hewlett-Packard Company 2001-02. A portion of the disclosure of this patent document contains material which is subject to copyright protection. The copyright owner has no objection to the facsimile reproduction by anyone of the patent document or the patent disclosure, as it appears in the patent and trademark office patent file or records, but otherwise reserves all copyright rights whatsoever.

### TECHNICAL FIELD OF THE INVENTION

The present invention relates generally to the field of web-services, and more particularly to a system and method for defining process information for web-services.

### BACKGROUND OF THE INVENTION

WSDL (Web Services Description Language) is a web-services description language that describes web-services by specifying parts, messages, operations, ports, port types and services. WSDL comprises an XML (eXtensible Markup Language) vocabulary that standardizes how organizations describe web-services. A WSDL document includes various elements, which elements define and describe the web-services offered by the author of the WSDL document, for example a service provider.

BizTalk Messaging Framework provides a specification for the design and development of messaging solutions for communication between applications and organizations. This specification builds upon standard and emerging Internet technologies, such as Hypertext Transfer Protocol (HTTP), Multipurpose Internet Mail Extensions (MIME), XML, and Simple Object Access Protocol (SOAP). The BizTalk Messaging Framework specifies the format of an electronic message, such as a web-services message. It defines various SOAP header elements, such as a “process” element.

Using WSDL, a service provider can inform service requesters on how to access a service provided by the service provider. The service providers use WSDL to describe how their services can be used and to describe how the messages are to be built. Service requestors can access web-services remotely across the Internet using various protocols, for example SOAP or BizTalk Messaging Framework. Once the service requestor has the WSDL file for a specific web-service, it uses messages, for example SOAP messages, to communicate with the service provider. If these messages are SOAP messages, they may include SOAP header elements.

A web-services interface, for example a WSDL document, may describe a plurality of web-services provided by the service provider. Conversations between the service provider and the service requestor which extend for a long period may cause multiple instances of a specific web-service to be created. Each of these instances may have their own state. The service provider may receive different types of messages. When the service provider receives a message from the service requestor, the service provider may not be able to determine which of the plurality of services the service requestor has requested. Furthermore, in the case of a web-service with multiple instances, the service provider may not be able to determine for which instance of a web-service the message is intended.

### SUMMARY OF THE INVENTION

In accordance with an embodiment of the present invention, an electronic message comprising a port name element operable to specify at least one port of a server for providing a web-service, an operation name element operable to specify at least one operation for the at least one port and an operation message name element operable to specify at least one operation message for the at least one operation is disclosed.

In accordance with another embodiment of the present invention, a method for providing a web-service is disclosed. The method comprises determining whether a web-services message comprises a request for a valid port for providing a web-service, determining whether the web-services message comprises a request for a valid operation for the web-service, determining whether the web-services message comprises a valid operation message for the operation and processing the web-services message in response to the web-services message comprising a valid operation message for the operation.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a logical block diagram of a system which may use embodiments of the present invention to advantage;

FIG. 2 is a high-level block diagram of a system which may use embodiments of the present invention to advantage;

FIG. 3 is a diagram of a schema for a process element extension in accordance with an embodiment of the present invention;

FIG. 4 is an embodiment of a message that comprises a process element extension in accordance with the present invention; and

FIGS. 5A and 5B illustrate a flowchart of an exemplary method for processing, in accordance with an embodiment of the present invention, a message received by the service provider.

### DETAILED DESCRIPTION OF THE DRAWINGS

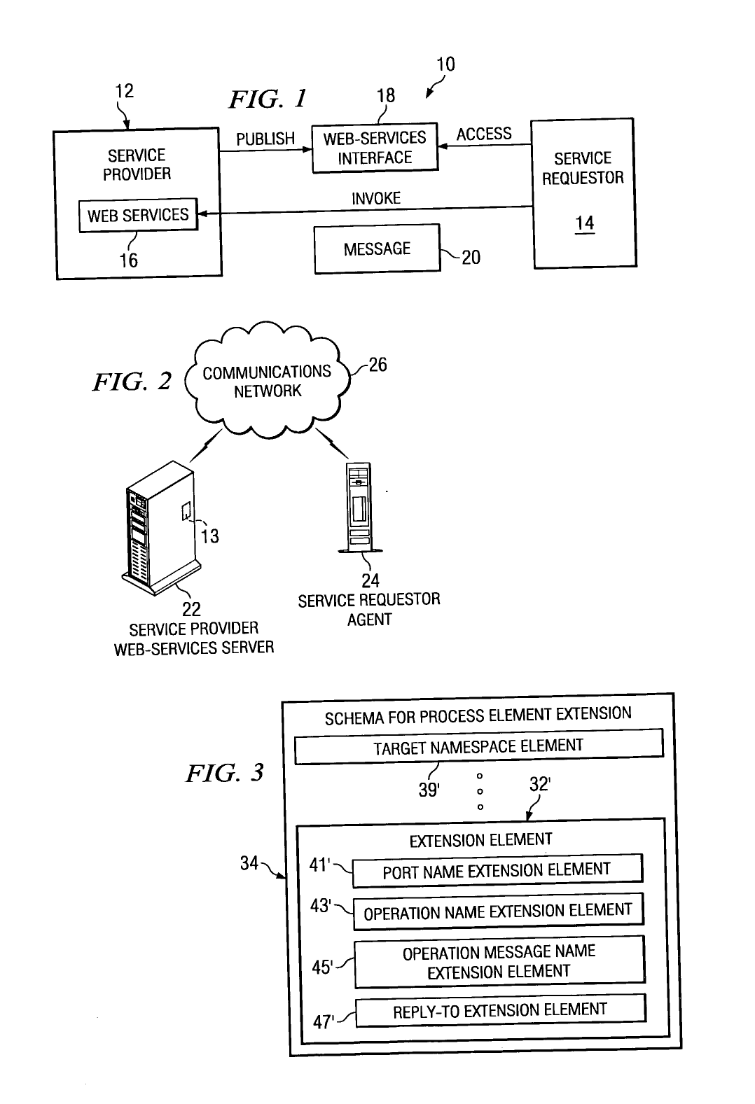

The preferred embodiment of the present invention and its advantages are best understood by referring to FIGS. 1 through 5 of the drawings, like numerals being used for like and corresponding parts of the various drawings.

In accordance with an embodiment of the present invention, a system and method for defining process information for web-services is disclosed. An exemplary system defines or specifies the information to be included in web-service messages to facilitate identification of the requested web-service. If desired, the information may be used to facilitate identification of the instance of the requested web-service. The web-service messages preferably comprise asynchronous web-service messages. Accordingly, a schema is provided which may be used by a service provider to define or specify the information desired in a message received from a service requester, such as a message requesting a web-service, which may be a message in accordance with an asynchronous messaging framework, for example BizTalk Messaging Framework or Simple Object Access Protocol (SOAP). The schema may be used by a service requestor to provide the desired information to the service provider. When a service provider receives a message, such as a web-services document or an XML (eXtended Markup Language) document, which includes the information as specified by the schema, the service provider is able to determine the particular web-service being requested and, if applicable, the instance of the requested web-service for which the message is intended. The service provider can then provide the requested web-service to the service requester.

FIG. 1 is a logical block diagram of a system 10 which may use embodiments of the present invention to advantage. System 10 comprises a service provider 12 and a service requestor 14. Service provider 12 is a provider of at least one web-service 16. Service provider 12 publishes at least one web-services interface 18. Web-services interface 18 preferably comprises a Web Services Description Language (WSDL) interface, e.g., a WSDL document. Web-services interface 18 defines the web-services that service provider 12 is capable of providing. Preferably, web-services interface 18 defines or specifies the format for a message 20 requesting web-service 16 that service provider 12 may receive from service requestor 14. Alternatively, the format for message 20 may be agreed upon between service provider 12 and service requestor 14 in advance of the message being sent to service provider 12.

Service requestor 14 requests one or more web-services 16 by transmitting message 20 to service provider 12. Message 20 may be a SOAP document, a message utilizing the BizTalk Messaging Framework specification, and/or the like. Message 20 preferably comprises a process element extension 32 in accordance with the schema of FIG. 3. The format of message 20 corresponds to the format defined by web-services interface 18 for the particular web-service being invoked/requested.

In an exemplary embodiment, a service provider web-services server 22 (FIG. 2) is communicatively coupled with a service requestor agent 24. Web-services server 22 may be provided by service provider 12. Web-services server 22 is capable of providing one or more web-services 16. Web-services server 22 may comprise one or more ports 13. A web-service may be assigned one or more of the plurality of ports. A port may correspond to one or more operations of the web-service. Service requestor 14 may utilize service requestor agent 24 to request web-services from web-services server 22 and/or invoke operations on web-services server 22 via a communications network 26. If desired, service requestor agent 24 may also comprise one or more ports.

FIG. 3 is a diagram of a schema 34 for a process element extension in accordance with an embodiment of the present invention. An exemplary schema is provided in APPENDIX A. A portion of an exemplary message in accordance with schema 34 is provided in APPENDIX B. Schema 34 comprises of a plurality of elements. These elements are discussed in detail hereinafter.

Schema 34 comprises a target namespace element 39′, for example <xsd:schema targetNamespace=“http://schemas.hp.com/web-services/biztalk/process_WSDLextension”>. Target namespace element 39′ preferably defines an identifier, for example a Uniform Resource Locator (URL) (http://schemas.hp.com/web-services/biztalk/process_WSDLextension), that uniquely references an extension to a specification, for example a process element extension to a specification of a messaging framework, such as the BizTalk Messaging Framework. The address specified in a namespace element 39 of exemplary message 20 preferably corresponds to the address defined in target namespace element 39′.

Schema 34 also comprises an extension element 32′. Following is an exemplary definition of an extension element:

<xsd:element name=“wsdlDetail” type=“hpExt:wsdlDetailType”>
. . .
</xsd:element>

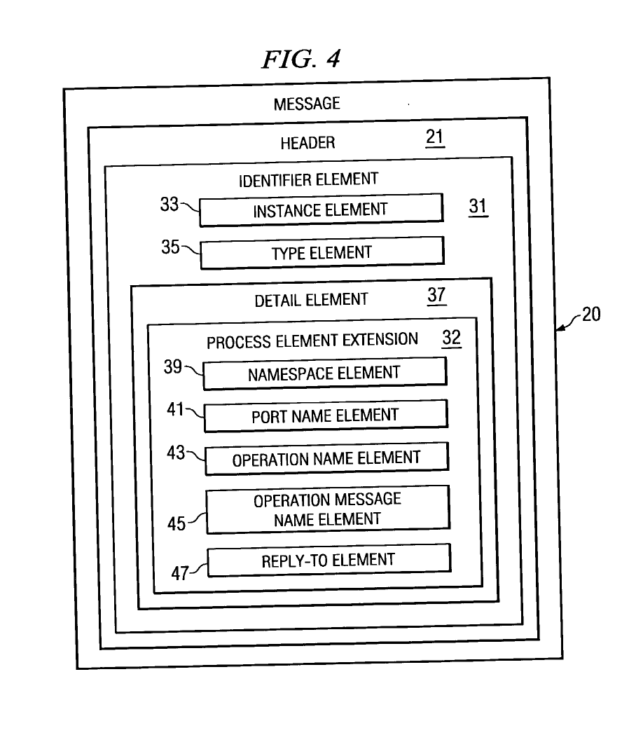

Extension element 32′ specifies that the process element extension of exemplary message 20 be named wsdlDetail. As illustrated in the exemplary message of APPENDIX B, the name of process element extension 32 of exemplary message 20 (FIG. 4) is preferably identical to the name defined in extension element 32′ of schema 34 of FIG. 3.

An element of a schema may have a documentation sub-element within an annotation sub-element. For example, in the example of APPENDIX A, extension element 32′ comprises the following annotation element:

```
<xsd:annotation>
  <xsd:documentation>Child element of the element Header:process:detail
  of a SOAP header of a BizTalk message that uses the WSDL extension
  for describing the process details.
  </xsd:documentation>
</xsd:annotation>
```

The documentation sub-element specifies the function of the element to which it belongs in human-readable form so that an operator associated with service requestor 14 could understand the format of message 20 to be transmitted to service provider 12.

Extension element 32′ is of type wsdlDetailType. In the example of APPENDIX A, an extension definition element defines an element of type wsdlDetailType. Following is an example of an extension definition element:

<xsd:complexType name=“wsdlDetailType”>
. . .
</xsd:complexType>

The extension definition element comprises a sequence sub-element xsd:sequence. Following is an example of a sequence sub-element:

```
<xsd:sequence>
  xsd:element ref=“hpExt:portName”/>
  <xsd:element ref=“hpExt:operationName”/>
  <xsd:element ref=“hpExt:operationMessageName”/>
  <xsd:element ref=“hpExt:inReplyTo” minOccurs=“0”/>
</xsd:sequence>
```

The sequence sub-element provides a list of elements which comprise extension element 32′ and which according to schema 34 comprise message 20. Preferably, the sequence sub-element also specifies the sequence in which the elements occur in message 20. Extension element 32′ comprises a plurality of elements, such as a port name extension element 41′, an operation name extension element 43′, an operation message name extension element 45′, and a reply-to extension element 47′, as listed in the above sequence sub-element. An element listed in the sequence sub-element may be further defined. In the above example, reply-to extension element 47′ is further defined as having a minimum occurrence value of zero (minOccurs=“0”), which indicates that this element is optional in message 20.

In the example of APPENDIX A, following the extension definition element are definitions for the other elements listed under the sequence sub-element. Following is a definition for port name extension element 41′:

```
<xsd:element name=“portName” type=“xsd:NCName”>
  <xsd:annotation>
    <xsd:documentation>Contains the value of the attribute name of the
    element definitions/service/port of the corresponding WSDL
    description.</xsd:documentation>
  </xsd:annotation>
</xsd:element>
```

According to port name extension element 41′, a port name element 41 of message 20 (FIG. 4) preferably comprises the name of the port on service provider web-services server 22 to be used for the web-service. According to the above example, port name extension element 41′ preferably specifies that port name element 41 of message 20 comprises the value of the attribute name of an element definitions/service/port of the corresponding WSDL description. Port name element 41 is of type NCName. NCName stands for non-colon name which comprises of one or more characters, such as alphabets, digits, hyphens, underscores and/or periods. It may start with an alphabet or an underscore. Preferably, NCName does not comprise a colon (“:”).

Following is a definition for operation name extension element 43′:

```
<xsd:element name=“operationName” type=“xsd:NCName”>
  <xsd:annotation>
    <xsd:documentation>Contains the value of the attribute name of the
    element definitions/port Type/operation of the corresponding WSDL
    description.</xsd:documentation>
  </xsd:annotation>
</xsd:element>
```

A service may comprise of one or more operations. For example, a StoreFrontService may comprise of one or more of the following operations—Login, Purchase, Logout and Shipping. According to operation name extension element 43′, an operation name element 43 of message 20 (FIG. 4) preferably comprises the name of the operation being requested or invoked by message 20. According to the above example, operation name extension element 43′ preferably specifies that an operation name element 43 of message 20 comprises the value of the attribute name of an element definitions/portType/operation of the corresponding WSDL description. Operation name element 43 is of type NCName.

Following is a definition for operation message name extension element 45′:

```
<xsd:element name=“operationMessageName” type=“xsd:NMTOKEN”>
  <xsd:annotation>
    <xsd:documentation>Contains the value of the attribute name of the
    element of definitions/portType/operation/input, definitions/portType/
    operation/output  or definitions/portType/operation/fault  of  the
    corresponding WSDL description.</xsd:documentation>
  <xsd:annotation>
</xsd:element>
```

An operation may accept any of a plurality of operation messages as an input. According to operation message name extension element 45′, an operation message name element 45 of message 20 (FIG. 4) preferably comprises an operation message for the requested operation. According to the above example, operation message name extension element 45′ preferably specifies that operation message name element 45 of message 20 comprises the value of the attribute name of an element definitions/portType/operation/input, definitions/portType/operation/output, or definitions/portType/operation/fault of the corresponding WSDL description. Operation message name element 45 is of type NMTOKEN. NMTOKEN is preferably a name token comprising of one or more characters, such as alphabets, digits, hyphens, underscores and/or periods.

Following is a definition for reply-to extension element 47′:

```
<xsd:element name=“inReplyTo” type=“xsd:NMTOKEN”>
  <xsd:annotation>
    <xsd:documentation> In case of solicit-response and request-response
    operations, value of the operation message name element of the
    message to which this message is a reply.</xsd:documentation>
  </xsd:annotation>
</xsd:element>
```

A message from service requestor 14 may be a response to another message. According to reply-to extension element 47′, message 20 comprises a reply-to element 47 if message 20 is a response message in the case of a Request-Response operation or a Solicit-Response operation. It identifies the message to which the current message is a reply. The operations Request-Response and Solicit-Response are defined by a specification for WSDL, for example the WSDL 1.1 specification. According to the above example, a reply-to element 47 of message 20 preferably comprises the value of the operation message name element of the message to which the current message is a reply. Reply-to element 47 is of type NMTOKEN.

FIG. 4 is an embodiment of a message 20 that comprises a process element extension 32 in accordance with the present invention. Process element extension 32 is preferably part of a header 21 of message 20. However, if desired, process element extension 32 may be part of the body of message 20. Message 20 is preferably generated by service requestor 14 and transmitted to service provider 12. If desired, message 20 may be generated by service provider 12.

Message 20 comprises an identifier element 31. An exemplary identifier element 31 is provided below:

<prc:process
. . .
</prc:process>

Identifier element 31 specifies a unique identifier, for example a URL (http://schemas.BizTalk.org/btf-2-0/process), that may be used to uniquely reference a specification, for example a specification for the BizTalk Messaging Framework. A portion (xmlns.prc=“http://schemas.BizTalk.org/btf-2-0/process”) of identifier element 31 as illustrated in APPENDIX B indicates that the elements or sub-elements starting with prc are defined by the specification referenced by the unique identifier.

Identifier element 31 comprises an instance element 33. Following is an exemplary instance element:

<prc:instance>15.81.93.229.2d086a.e93567e75c.-8000</prc:instance>

Instance element 33 preferably specifies an identifier for the current conversation instance. Instance element 33 is preferably used for correlation as multiple instances of a web-service may be executing concurrently. Preferably, the identifier is unique between a particular service provider and a particular service requestor. However, the identifier could be a globally unique identifier.

Identifier element 31 preferably also comprises a type element 35, for example <prc:type>StoreFrontService</prc:type>. Type element 35 preferably comprises the name of the web-service to be used. Preferably, it references an attribute name of an element service of the corresponding WSDL description. According to the above example, the name of the web-service to be used is StoreFrontService.

Identifier element 31 preferably also comprises a detail element 37. Following is an exemplary detail element:

<prc:detail>
. . .
</prc:detail>

Detail element 37 comprises process element extension 32 in accordance with schema 34 (FIG. 3). Following is an example of process element extension:

```
<wsdlExt:wsdlDetail . . .
  <wsdlExt:portName>SimpleStoreFront</wsdlExt:portName>
  <wsdlExt:operationName>Login</wsdlExt:operationName>
  <wsdlExt:operationMesssageName>LoginRQ</
  wsdlExt:operationMesssageName>
  <wsdlExt:inReplyTo>RegistrationRS</wsdlExt:inReply To>
</wsdlExt:wsdlDetail>
```

Process element extension 32 includes the information desired by web-services server 22 to be included in an electronic or computer message, such as a web-services message, to determine which one of the plurality of web-services is being requested by service requestor agent 24. If desired, the particular instance of the web-service being requested may also be determined. Namespace element 39, such as an eXtensible Markup Language Namespace (xmlns:wsdlExt), of process element extension 32 specifies a unique identifier, for example a URL, that may be used to uniquely identify an extension to a specification, for example a process element extension to a specification of a messaging framework, such as the BizTalk Messaging Framework. Following is an exemplary namespace element:

xmlns:wsdlExt=“http://schemas.hp.com/web-services/biztalk/process_WSDLextension”.

The above namespace element indicates that the elements or sub-elements starting with wsdlExt are defined by the specification extension referenced by the unique identifier (http://schemas.hp.com/web-services/biztalk/process_WSDLextension). Preferably, the unique identifier corresponds to the unique identifier specified in namespace element 39′ of schema 34.

In accordance with an embodiment of the present invention, process element extension 32 comprises a plurality of elements. Preferably, process element extension 32 is comprised of the elements specified by extension element 32′ of schema 34, such as port name element 41, operation name element 43, and operation message name element 45. Process element extension 32 may also comprise reply-to element 47. The elements of process element extension 32 preferably reference various values provided by the corresponding WSDL description.

In the above example of a process element extension, port name element 41 is specified as <wsdlExt:portName>SimpleStoreFront</wsdlExt:portName>, which specifies that the name of the port on service provider web-services server 22 to be used is SimpleStoreFront; operation name element 43 is specified as <wsdlExt:operationName>Login</wsdlExt:operationName>, which specifies that the operation to be executed in response to receipt of message 20 is Login; and operation message name element 45 is specified as <wsdlExt:operationMesssageName>LoginRQ</wsdlExt:operationMesssageName>, which specifies that the name of the operation message for the Login operation is a login request message, for example LoginRQ. Preferably, port name element 41, operation name element 43 and operation message name element 45, together uniquely identify the web-service for which the message is being exchanged. In the above example, reply-to element 47 is specified as <wsdlExt:inReplyTo>RegistrationRS</wsdlExt:inReplyTo>, which specifies that the current message is a response to a previous message whose operation message name element value was RegistrationRS.

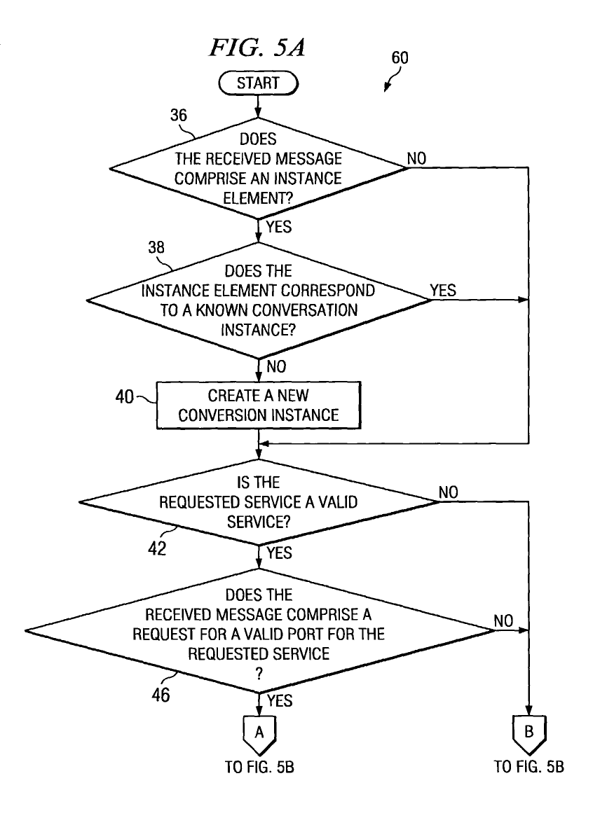

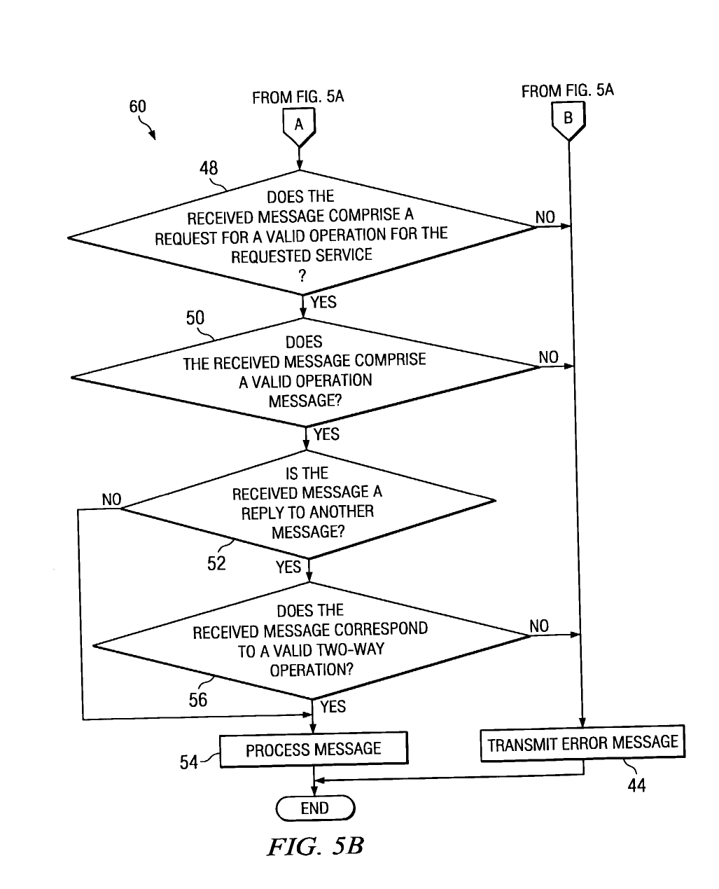

FIGS. 5A and 5B illustrate a flowchart of an exemplary method 60 for processing, in accordance with an embodiment of the present invention, a message received by the service provider. Method 60 is preferably executed by the service provider upon receipt of a message.

It is possible that the received message may not comprise an instance element. As such, in step 36, a determination is made as to whether the received message comprises an instance element. If the received message does not comprise an instance element, then the process starting at step 42 may be executed. Otherwise, in step 38, a determination is made as to whether the instance element corresponds to a known conversation instance. If the instance element of the received message corresponds to a known conversation instance, then the process starting at step 42 may be executed. Otherwise, in step 40, a new conversation instance may be created and the process starting at step 42 executed. In an alternative embodiment, if the instance element of the received message does not correspond to a known conversation instance, then the process starting at step 44 may be executed.

It is possible that the service provider does not provide the requested service. As such, it is desirable to determine if the requested service is a valid service. In step 42, a determination is made as to whether the requested service is a valid service. Preferably, this determination is made by comparing the name of the requested service as listed in type element 35 of the message with the service name listed in web-services interface 18. If the requested service and the service name listed in web-services interface 18 do not match, then in step 44, an error message may be transmitted to the service requester.

If in step 42, it is determined that the requested service is a valid service, then in step 46, a determination is made as to whether the received message comprises a request for a valid port for the requested service. Preferably, this determination is made by comparing the port name in the received message (the requested port name), for example as listed in port name element 41 of exemplary message 20 (FIG. 4), with the port name(s) listed for the requested service in web-services interface 18. If the requested port name does not match any of the listed port names, then an error message may be transmitted to the service requestor (step 44).

If in step 46, it is determined that the received message comprises a request for a valid port, then in step 48, a determination is made as to whether the received message comprises a request for a valid operation for the requested service. Preferably, this determination is made by comparing the operation name in the received message (the requested operation name), for example as listed in operation name element 43 of exemplary message 20 (FIG. 4), with the operation name(s) listed for the requested service in web-services interface 18. If the requested operation name does not match any of the listed operation names, then an error message may be transmitted to the service requestor (step 44).

If in step 48, it is determined that the received message comprises a request for a valid operation, then in step 50, a determination is made as to whether the received message comprises a valid operation message. Preferably, this determination is made by comparing the operation message name in the received message (the requested operation message name), for example as listed in operation message name element 45 of exemplary message 20 (FIG. 4), with the operation message name(s) listed for the requested operation in web-services interface 18. If the requested operation message name does not match any of the listed operation message names, then an error message may be transmitted to the service requestor (step 44).

Otherwise, in step 52, a determination is made as to whether the received message is a reply to another message. Preferably, this determination is made by checking the received message to determine if the received message comprises a reply-to element, for example reply-to element 47 (FIG. 4). If the received message is not a reply to another message, then in step 54, the received message is processed based at least in part on the requested operation. If in step 52, it is determined that the received message is a reply to another message, then in step 56, a determination is made as to whether the received message corresponds to a valid two-way operation. Preferably, this determination is made by comparing a value included in a reply-to element of the received message, for example as provided in reply-to element 47 of exemplary message 20 (FIG. 4), with the names of the valid initial messages in the operation for which this message is a response message. If in step 56, it is determined that the received message does not correspond to a valid two-way operation, then an error message may be transmitted to the service requester (step 44). Otherwise, the received message is processed based at least in part on the requested operation (step 54).

The present invention may be implemented in software, hardware, or a combination of both software and hardware. The software and/or hardware may reside on service provider web-services server 22 and/or service requestor agent 24.

If desired, the different steps discussed herein may be performed in any order and/or concurrently with each other. Furthermore, if desired, one or more of the above described steps may be optional or may be combined without departing from the scope of the present invention.

A technical advantage of an exemplary embodiment of the present invention is that a service provider receiving a web-services message is able to identify the web-service being requested. Another technical advantage of an exemplary embodiment of the present invention is that a service provider receiving a web-services message is able to identify the instance of the web-service being requested.

### APPENDIX

### Appendix A

```
<xsd:schema targetNamespace=“http://schemas.hp.com/web-services/biztalk/process_WSDL
extension”>
<xsd:element name=“wsdlDetail” type=“hpExt:wsdlDetailType”>
  <xsd:annotation>
    <xsd:documentation>Child element of the element Header:process:detail of a
    SOAP header of a BizTalk message that uses the WSDL extension for
    describing the process details.</xsd:documentation>
  </xsd:annotation>
</xsd:element>
<xsd:complexType name=“wsdlDetailType”>
  <xsd:annotation>
    <xsd:documentation>wsdlDetailType denotes which message according to the
    WSDL description is being exchanged. The types of the various sub-elements
    correspond to the types of the corresponding attributes/elements in the WSDL
    description.</xsd:documentation>
  </xsd:annotation>
  <xsd:sequence>
    <xsd:element ref=“hpExt:portName”/>
    <xsd:element ref=“hpExt:operationName”/>
    <xsd:element ref=“hpExt:operationMessageName”/>
    <xsd:element ref=“hpExt:inReplyTo” minOccurs=“0”/>
  </xsd:sequence>
</xsd:complexType>
<xsd:element name=“portName” type=“xsd:NCName”>
  <xsd:annotation>
    <xsd:documentation>Contains the value of the attribute name of an element
    definitions/service/port of the corresponding WSDL description.
    </xsd:documentation>
  </xsd:annotation>
</xsd:element>
<xsd:element name=“operationName” type=“xsd:NCName”>
  <xsd:annotation>
    <xsd:documentation>Contains the value of the attribute name of an element
    definitions/portType/operation of the corresponding WSDL description.
    </xsd:documentation>
  </xsd:annotation>
</xsd:element>
<xsd:element name=“operationMessageName” type=“xsd:NMTOKEN”>
  <xsd:annotation>
    <xsd:documentation>Contains the value of the attribute name of an element of
    definitions/portType/operation/input, definitions/portType/operation/output or
    definitions/portType/operation/fault of the corresponding WSDL description.
    </xsd:documentation>
  <xsd:annotation>
</xsd:element>
<xsd:element name=“inReplyTo” type=“xsd:NMTOKEN”>
  <xsd:annotation>
    <xsd:documentation> In case of solicit-response and request-response
    operations, value of the operation message name element of the message to
    which this message is a reply.</xsd:documentation>
  </xsd:annotation>
</xsd:element>
</xsd:schema>
```

### Appendix B

```
<prc:process . . .
  xmlns:prc=“http://schemas.BizTalk.org/btf-2-0/process” >
  <prc:instance>15.81.93.229.2d086a.e93567e75c.-8000</prc:instance>
      <--! prc:instance is desirable if an extended WSDL with
      conversation is used. It provides an Id of the conversation
      instance-->
  <prc:type>StoreFrontService</prc:type>
    <--! Name of the service as given by wsdl:service -->
  <prc:detail>
    <wsdlExt:wsdlDetail
      xmlns:wsdlExt=“http://schemas.hp.com/web-services/
      biztalk/process_{—}
      WSDLextension”>
    <wsdlExt:portName>SimpleStoreFront</wsdlExt:portName>
    <wsdlExt:operationName>Login</wsdlExt:operationName>
    <wsdlExt:operationMesssageName>LoginRQ</
    wsdlExt:operationMesssage
    Name>
      <--! Value of name attribute of input, output or fault element of the
        operation, not the name of the message referenced -->
    <wsdlExt:inReplyTo>RegistrationRS</wsdlExt:inReplyTo>
      <--! Used in responses, gives name of request message -->
    </wsdlExt:wsdlDetail>
  </prc:detail>
</prc:process>
```

What is claimed is:

1. An electronic message, comprising:
a port name element operable to specify at least one port of a server for providing a web-service;
an operation name element operable to specify at least one operation for said at least one port; and
an operation message name element operable to specify at least one operation message for said at least one operation.

2. The electronic message of claim 1, further comprising a reply-to element operable to specify said electronic message is in reply to another message.

3. The electronic message of claim 1, wherein said electronic message is an asynchronous web-services message.

4. The electronic message of claim 1, wherein said electronic message is operable to identify said web-service as a requested service.

5. The electronic message of claim 1, wherein said electronic message is operable to identify a specific instance of said web-service.

6. The electronic message of claim 1, further comprising a header comprising said port name element, said operation name element and said operation message name element.

7. The electronic message of claim 1, further comprising an identifier operable to identify a conversation instance.

8. A method for providing a web-service, comprising:
determining whether a web-services message comprises a request for a valid port for providing a web-service;
determining whether said web-services message comprises a request for a valid operation for said web-service;
determining whether said web-services message comprises a valid operation message for said operation; and
processing said web-services message in response to said web-services message comprising a valid operation message for said operation.

9. The method of claim 8, wherein said determining whether said web-services message comprises a request for a valid operation comprises determining whether said web-services message comprises said request for a valid operation for said web-service, in response to said web-services message comprising a request for a valid port for providing said web-service.

10. The method of claim 8, wherein said determining whether said web-services message comprises a valid operation message comprises determining whether said web-services message comprises said valid operation message for said operation, in response to said web-services message comprising a request for a valid operation for said web-service.

11. The method of claim 8, wherein said processing comprises processing said web-services message based at least in part on said request for said operation.

12. The method of claim 8, further comprising:
determining, prior to said processing, whether said web-services message is a reply to another message; and
determining whether said web-services message corresponds to a valid two-way operation, in response to a determination that said web-services message is a reply to another message.

13. The method of claim 8, further comprising comparing a port name listed in a port name element of said web-services message with at least one port name for said web-service listed in a web-services interface to determine whether said web-services message comprises said request for a valid port for providing said web-service.

14. The method of claim 8, further comprising comparing an operation name listed in an operation name element of said web-services message with at least one operation name for said web-service listed in a web-services interface to determine whether said web-services message comprises said request for a valid operation for said web-service.

15. The method of claim 8, further comprising comparing an operation message name listed in an operation message name element of said web-services message with at least one operation message name for said operation listed in a web-services interface to determine whether said web-services message comprises said valid operation message for said operation.

16. The method of claim 8, further comprising transmitting an error message in response to said web-services message comprising a request for an invalid port for providing said web-service.

17. The method of claim 8, further comprising transmitting an error message in response to said web-services message comprising a request for an invalid operation for said web-service.

18. The method of claim 8, further comprising transmitting an error message in response to said web-services message comprising an invalid operation message for said operation.

19. The method of claim 8, further comprising:
specifying at least one port of a web-services server for providing said web-service;
specifying at least one operation for said at least one port; and
specifying at least one operation message for said at least one operation.

20. The method of claim 8, further comprising defining a web-services description language document for said web-service.

21. The method of claim 8, further comprising defining a name for said web-service.
